(19) United States
(12) Patent Application Publication
(10) Pub. No.: US 2008/0230949 A1
(43) Pub. Date: Sep. 25, 2008

(54) Injection molding process for forming coated molded parts

(76) Inventors: Paul Razgunas, Canton, MI (US); Alan Maddaford, Farmington Hills, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 11/728,084

(22) Filed: Mar. 23, 2007

(51) Int. Cl. B32B 33/00

(52) U.S. Cl. 264/255

(57) ABSTRACT

A method for molding color-coated plastic parts is disclosed. The method includes a technique for applying a color layer to the surface of sections of a mold when the mold is closed, and distributing a substrate into a cavity defined by the mold sections whereby the last point of fill for the substrate is located at an entry location of a color material.

### BACKGROUND OF THE INVENTION

1. Field of the Invention

The invention relates to injection coating technology (ITC) in a molding process.

2. Background Art

Injection molding parts comprised of plastic material, such as polyurethane, polypropylene, thermo-plastic olefin, for example, is a well-known process. A more recently developed injection molding process using known molding techniques for forming color-coated parts involves applying a color coating to an injection mold prior to injection of mold material or substrate into the mold so that the molded part, when ejected from the mold, would have a coating with selected characteristics, such as an enamel finish with any of a variety of colors. A coating film typically would be applied to an open mold by various method steps, such as spraying. This technique is disclosed, for example, in U.S. Pat. Nos. 5,912,081, 5,082,069 and 4,282,285. An injection molding process for forming color-coated plastic parts also may use a technique disclosed in U.S. Pat. No. 5,656,215 in which a substrate or melt is encased by a selected enamel before it is injected into a mold cavity after the mold sections are closed, but prior to introduction of a substrate.

Known prior art injection molding processes for forming coated plastic parts require a long cycle time due to the fact that separate process steps are required for adding color coating material to a substrate. In addition, environmental issues are raised due to the necessity for using solvents that create airborne volatiles. Further, the coating material may have bonding characteristics that limit its ability to adhere to the substrate, thereby limiting the applications to which the injection molding process can be applied. In some instances, the color material may require a curing step to be added to the injection process prior to injection of the substrate into the mold or in a post-ejection step, which again may increase the cycle time.

### SUMMARY OF THE INVENTION

Although Applicant's disclosure relates to an injection molding process, the process steps can be used as well in other molding techniques, such as blow molding.

It is an objective of the present invention to provide a molding process for forming color-coated plastic parts with a reduced part manufacturing cycle time and which does not require application of the color coating material to the walls of the mold prior to closing of the mold parts. The invention makes it possible to omit post-molding painting steps typically used in certain conventional molding techniques, which would often require a separate part-drying production line in a high volume manufacturing facility.

An additional feature of the invention makes it possible to manufacture color-coated plastic parts on a made-to-order basis in a high volume production facility. This makes possible high volume manufacture of color-coated parts of different color in a single batch of parts. The process of the invention also will permit multi-color layering.

One aspect of the invention involves introducing a coating material into a mold cavity and then evacuating the coating material from the mold cavity as a substrate is fed into the mold cavity. The coating material is introduced into the mold cavity at a last point of fill of the substrate following a preceding step in which the substrate enters the mold cavity. The coating material is recovered as the substrate is injected and then is reused in the next molding cycle.

The molds and the tooling used in practicing the invention can be modified conventional molds and tooling. The gloss level of the color-coated part manufactured using the process of the invention can be dependent on the coating material, the mold cavity finish and the mold temperature. The mold cavity finish can be adjusted using a variety of polishing and cleaning techniques. The coating thickness can be varied as desired depending on the mold temperature and the process time that is selected. Although a conventional post-cure step may be required, such as thermal baking or ultraviolet curing upon removal of the colored part from the mold, most parts can be cured in the mold itself prior to ejection.

The substrate and the coating can be mutually chemically neutral. An example would be a ground polyvinyl chloride ABS with a polyurethane binder over a polypropylene, ground glass and mineral filled substrate.

If the process steps require a frequent change of color during a given production run, Applicant's process provides for purging the mold before the molding technique is repeated on a change in color selection so that the color used in a preceding cycle will not contaminate the color used in the current cycle.

The characteristics of the process of the invention will provide for a user a competitive advantage with respect to conventional molding processes by reducing manufacturing cost and cycle time and by improving quality of finished parts.

### BRIEF DESCRIPTION OF THE DRAWINGS

FIG. 1 is a schematic representation of a mold comprising mold parts that are shown in the open position, the mold being constructed in accordance with industry standards with air vents and mold entry ports for the mold material;

FIG. 2 is a schematic representation of injection mold parts in the closed position as a coating material is introduced into the mold;

FIG. 3 is a schematic illustration of an injection mold with the mold parts in the closed position as the substrate is introduced into the mold cavity and as the coating material is evacuated;

FIG. 4 is an isometric view of an automotive plastic bumper cover, which illustrates the advancing flow front of the substrate toward last points of fill;

FIG. 5 is a schematic representation of an injection mold with the mold parts open as the finished part is removed from the mold;

FIG. 6 is a process flowchart showing the sequential steps used in the injection coating process of the invention;

FIG. 7 is a schematic representation of a system that embodies the present invention wherein color-coated parts can be manufactured on demand using multiple color materials;

FIG. 8 is a schematic representation of process steps used in the parts on demand technique illustrated in FIG. 7;

FIG. 9 is a chart showing examples of coating and substrate combinations that may be used in practicing the invention;

FIG. 10 is an illustration of the process steps used in practicing the present invention during a given molding cycle;

FIG. 11 is a schematic illustration of a positive displacement pump with a refill tank that can be used in practicing the present invention; and

FIG. 12 is a schematic illustration of a mold that can be used in practicing the present invention, which includes a valve designed as a thermal valve located at the last point of fill of the substrate.

### DETAILED DESCRIPTION OF AN EMBODIMENT OF THE INVENTION

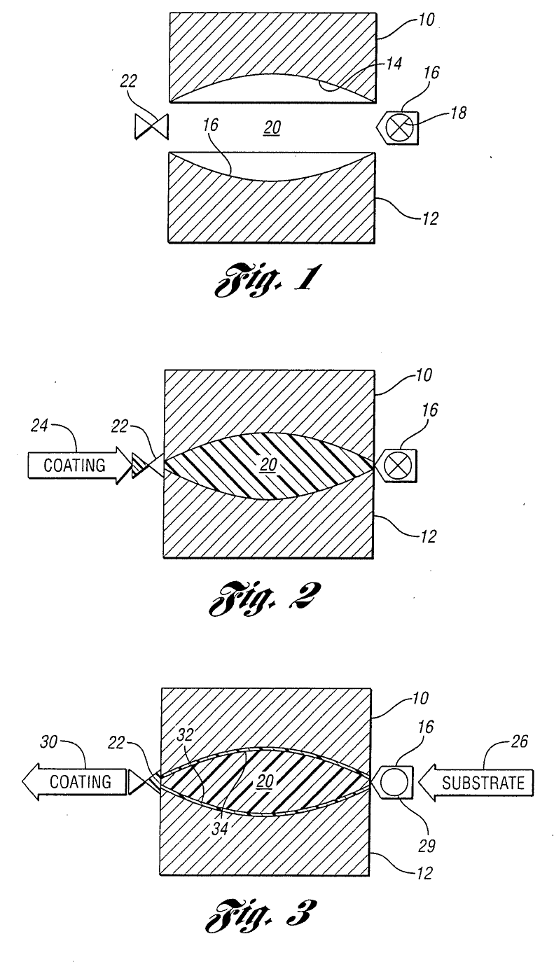

FIG. 1 is a schematic view of an injection mold with the mold sections in an open position and the mold cavity empty. The mold sections are shown at 10 and 12. The inner mold surfaces 14 and 16, respectively, can be textured, polished, plated or a combination of these steps. A substrate injector port is schematically shown at 16. The symbol 18 is used to indicate that the injection port is closed. The port 16 controls flow of substrate material to the mold cavity 20 defined by the mold sections. A coating material is distributed to the mold cavity through an opening defined by a bi-directional valve schematically shown at 22.

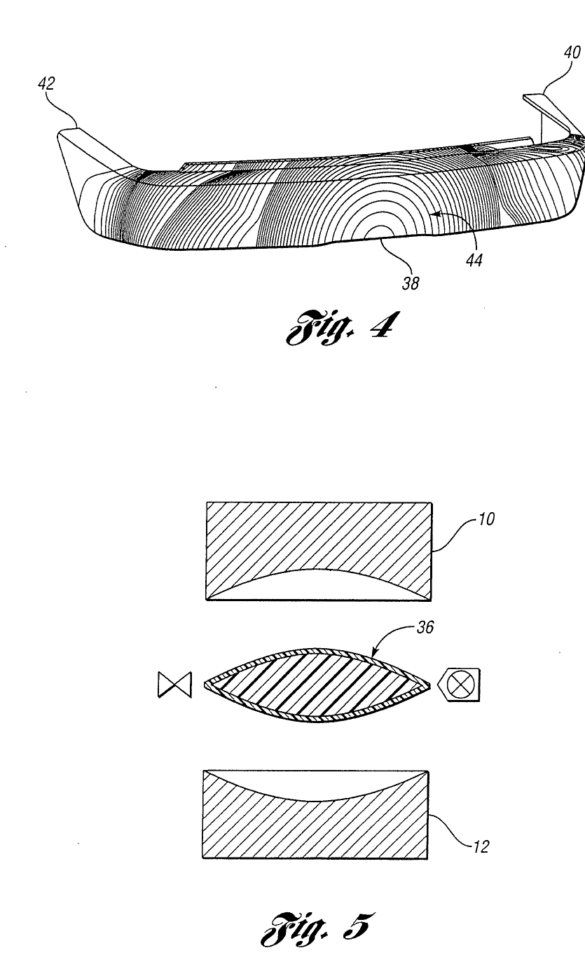

FIG. 2 shows the mold sections 10 and 12 in the closed position. The coating material enters the mold cavity 20 through the valve 22 as indicated by the directional arrow 24. The coating material can be a loose solid, liquid, semi-solid, or any of several of combinations of such material. The selection of a coating material depends mostly on the design requirements of the coating and its reactivity with respect to the substrate. Thermoset materials and thermo-plastic materials could be used. Precalibrated percentages of filler material, such as hollow glass spheres or metallic flakes, also could be used. The coating material forms a skin on the walls of the mold sections. After the coating skin is formed, the substrate material is introduced, as shown at 26 in FIG. 3, through the port 16. The symbol 28 is used to indicate that the port is open at this time.

As the substrate enters the mold cavity 20, the excess coating material is extracted from the cavity ahead of the substrate flow front, as shown at 30, through the valve 22 leaving a coating skin shown at 32 and 34 on the mold sections 12 and 10, respectively.

The valve 22 prevents the substrate from passing out of the mold cavity with the excess coating material. The location of the valve is at the last point of fill for the substrate.

When the coating and the substrate have taken a set, the finished part is removed from the mold, as seen in FIG. 5. The mold sections 10 and 12 are shown in FIG. 5 in the open position, permitting removal of the finished part 36, which comprises a substrate that is completely coated with coating material. The coating thickness will be dependent on the mold temperature and the processing time. The substrate material and the coating material are cured within the mold cavity, but final curing can be done in a post curing process, as previously described, if full cure is not achieved during molding.

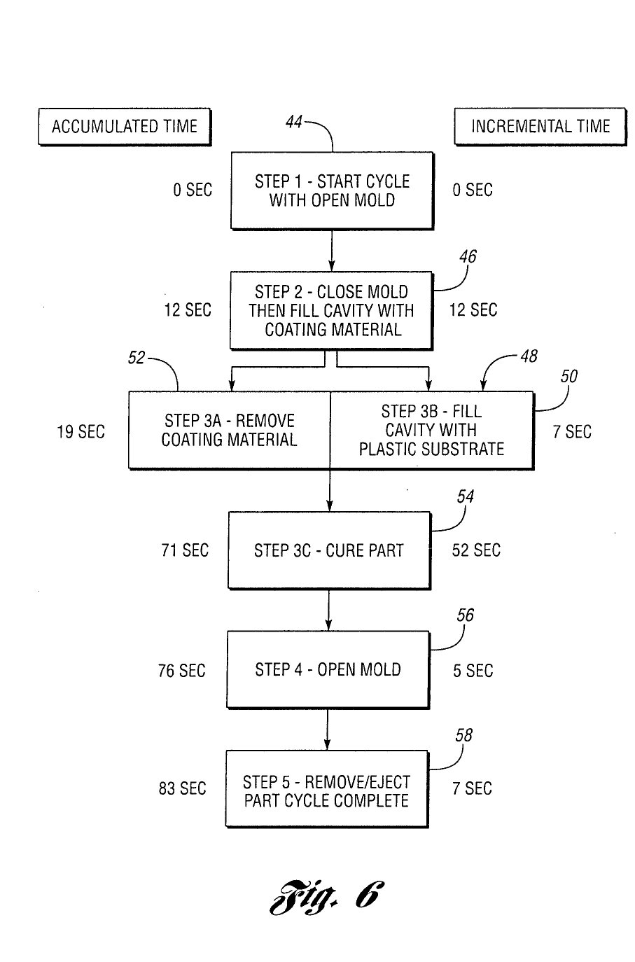

FIG. 4 illustrates an example of a molded part that can be manufactured using the process of the invention. The part shown in FIG. 4 is a plastic cover for an automotive vehicle bumper. The mold that is designed with the mold cavity intended for manufacturing the part shown in FIG. 4 would have a substrate entry port at location 38 near the center of the part. The last points of fill for the substrate would be at locations 40 and 42. When the substrate advances from the location 38 to locations 40 and 42, the color material is displaced toward the points 40 and 42 ahead of the substrate flow front. This is indicated by the advancing substrate surface features diagrammatically shown at 44. The extraction of the coating material is synchronized with the entry of the substrate into the cavity. The valve 22 prevents the substrate from passing out of the mold with the excess material, as previously mentioned.

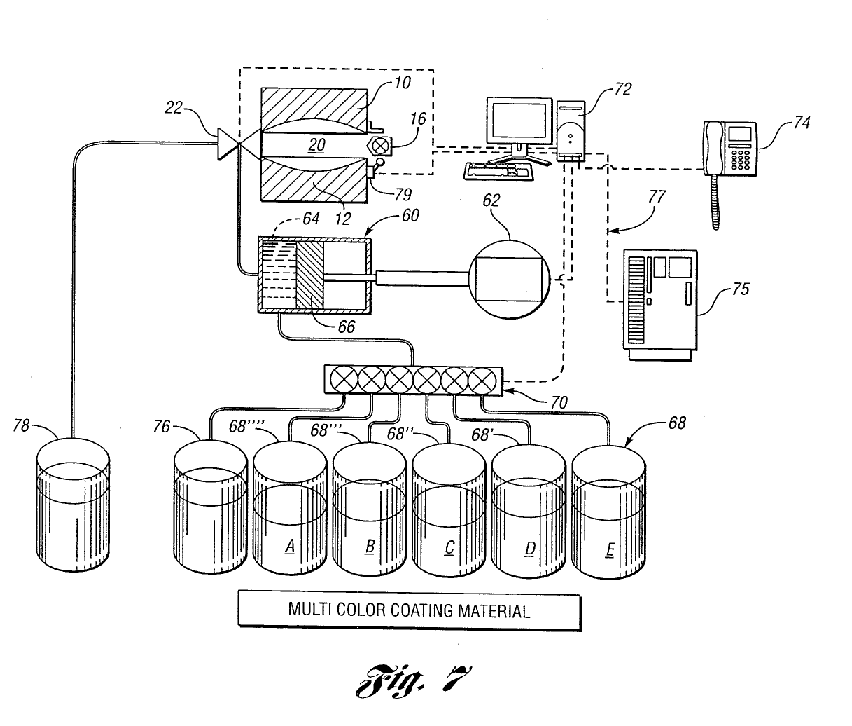

FIG. 6 shows a process flow diagram for the process steps previously described for manufacturing a part, such as the automobile bumper cover shown in FIG. 4, together with the time increments between the steps of the process. The process begins at 44 when the mold sections are in their open positions. Following the start of the molding cycle, the mold sections are closed and the mold cavity 20 is filled with coating material, which may require about 12 seconds in the case of a part of the type shown in FIG. 4. At the process step 48 the cavity is filled, as indicated at 50, and the coating material is removed simultaneously as shown at 52. These steps will occur in a time interval of about 7 seconds.

The part is cured in the mold cavity, as shown at step 54. The curing time may take about 52 seconds. After the part is cured, the mold is opened as shown at 56, which may require about 5 seconds, and the finished part is removed or ejected as a final step in the molding cycle, as shown at 58. This may require about 7 seconds in the case of a part of the type shown in FIG. 4. The overall cycle time illustrated in FIG. 6. Because the steps shown at 48 involve removal of the coating material while simultaneously filling the mold cavity with plastic substrate, the overall part manufacturing cycle time is increased by only about 7 seconds. In contrast, a conventional spray-on color-coating molding process would require about 180-480 seconds for a color spraying step and a color-coating curing step followed by molding time of about 70-90 seconds, for a total part manufacturing time of about 250-570 seconds. Further, in the case of a standard production paint line using a conventional process in which parts would be manufactured in batches, the part molding step would require about 70-90 seconds and the post-molding painting step would require about 3-5 hours, for a total part manufacturing time of about 10,000 seconds.

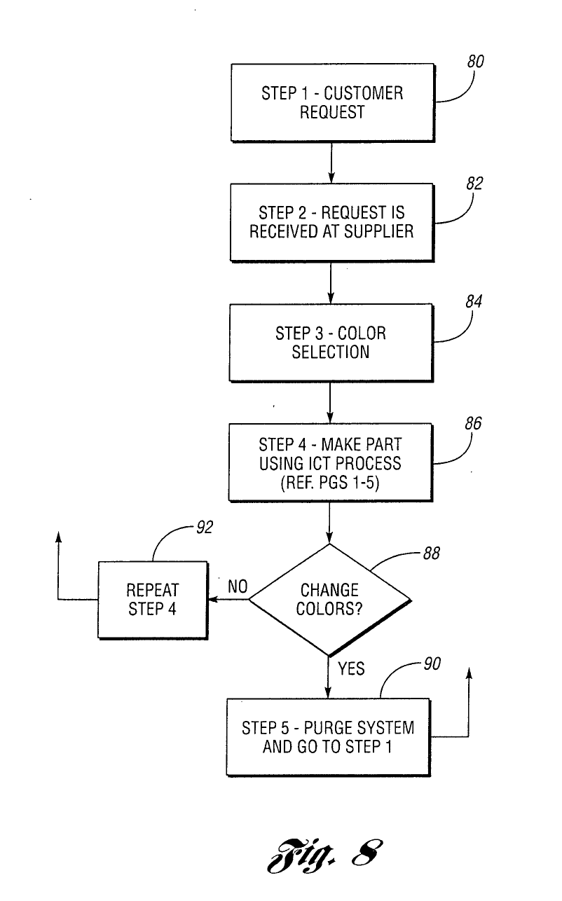

Shown schematically in FIG. 7 is a variation of the process illustrated in FIGS. 1 through 6. In FIG. 7 a pump 60 with a pump actuator 62 is adapted to transfer color material from a pump chamber 64 to the mold cavity 20 through the valve 22 as the piston 66 of the pump is stroked in a left direction, as seen in FIG. 7. When the piston 66 is stroked in the opposite direction, color material is drawn from one of group of color material reservoirs shown at 68 through 68″″. Different colors are identified in FIG. 7 by the letters “A”, “B”, “C”, “D” and “E”. A selector valve assembly, schematically shown at 70, will connect the pump chamber 64 with a selected one of the reservoirs as determined by an instruction from a supplier controller 72, which responds to a customer order entered at 74.

A control panel 75 for a press that actuates the mold sections includes a microprocessor to coordinate opening and closing of the mold sections with the valve selections at 70, and for controlling the actuator at 62 and the valve 22. Control signal flow paths are shown schematically at 77 with dotted lines. A travel limit switch for the mold sections is shown at 79. The switch 79 is set to interrupt the closing of the mold sections at a desired closed-mold position.

With the system shown at FIG. 7, a part on demand procedure can be carried out. Further multiple color layering can be achieved if that is desired.

During each color change, pump 60 will draw cleaning solvent through valve assembly 70 to fill the pump chamber 64 with cleaning solvent. During the pumping stroke of the piston 66, valve 22 will direct a flow of cleaning solvent from pump chamber 64 through the fluid flow lines leading to waste reservoir 78 to purge the fluid flow lines. The valve 22 at that time will interrupt fluid communication with mold cavity 20. After the purging, the pump then will draw a new color material through valve assembly 70 and deliver it through valve 22 to mold chamber 20. The new color material then is evacuated from mold cavity 20 upon entry of the substrate through entry port 16 to the appropriate reservoir 68-ε″″ selected by valve assembly 70.

FIG. 8 is a part-on-demand process flow diagram for the method steps used in the system illustrated in FIG. 7. The process begins by a customer request at 80. A request is received instantaneously at 82 by the supplier. A color selection then is made by the supplier as indicated at 84. The injection coating technology (ITC) process previously described then takes place as indicated at 86. At step 88 a decision is made regarding whether a color change is needed during a production run. If no color change is needed, the injection coating technology procedure is repeated as indicated at 92. If a color change is needed, a purge procedure previously described using the solvent and the reservoir 76 is carried out as indicated at 90. The procedure then returns to the beginning of the cycle as shown at 80.

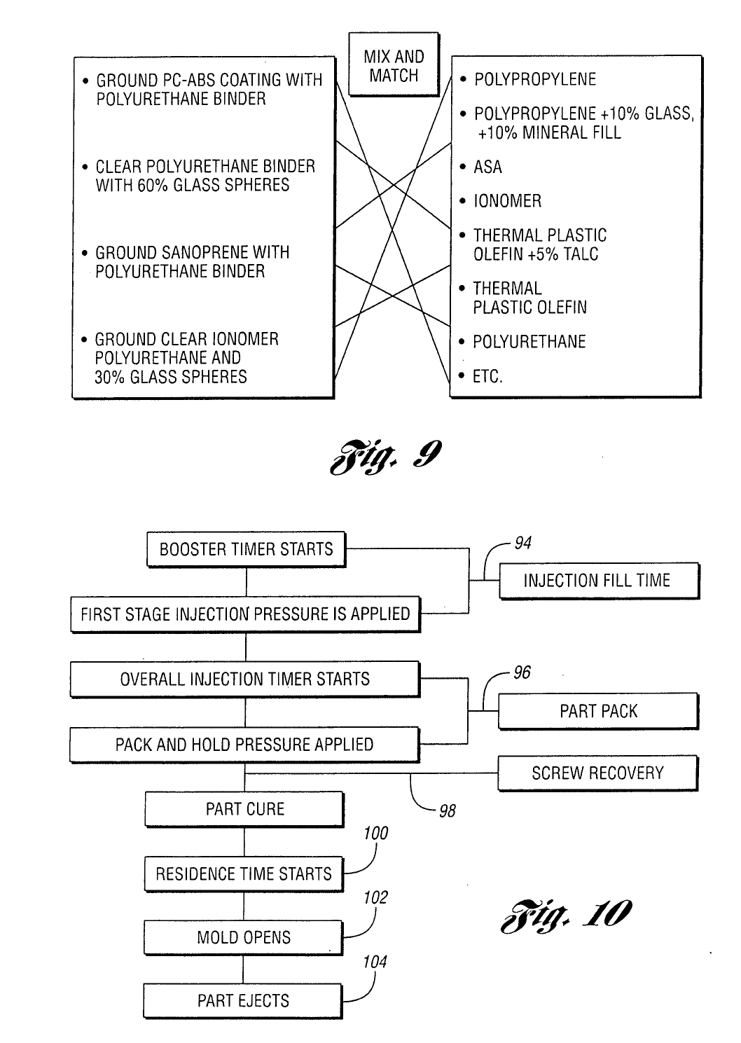

FIG. 9 is a chart indicating various coating and substrate combinations that could be used in the injection coating technology process. Examples of the coating materials are indicated at the left side of FIG. 9 and examples of substrate materials on the right side of FIG. 9. The various materials can be mixed and matched as required depending upon the desired appearance, surface characteristics and performance of the finished article upon removal from the mold.

FIG. 10 is a graphic illustration of the stages in a molding cycle that uses injection coating technology. The injection fill time involves setting timers and injection pressure as shown at 94. The overall injection timer starts and a pack and hold pressure is applied as shown at 96, which is followed by the substrate feeding screw recovery as shown at 98. After a calibrated cure time, a residence time starts at 100. The mold then is opened, as shown at 102, and the part is ejected as shown at 104.

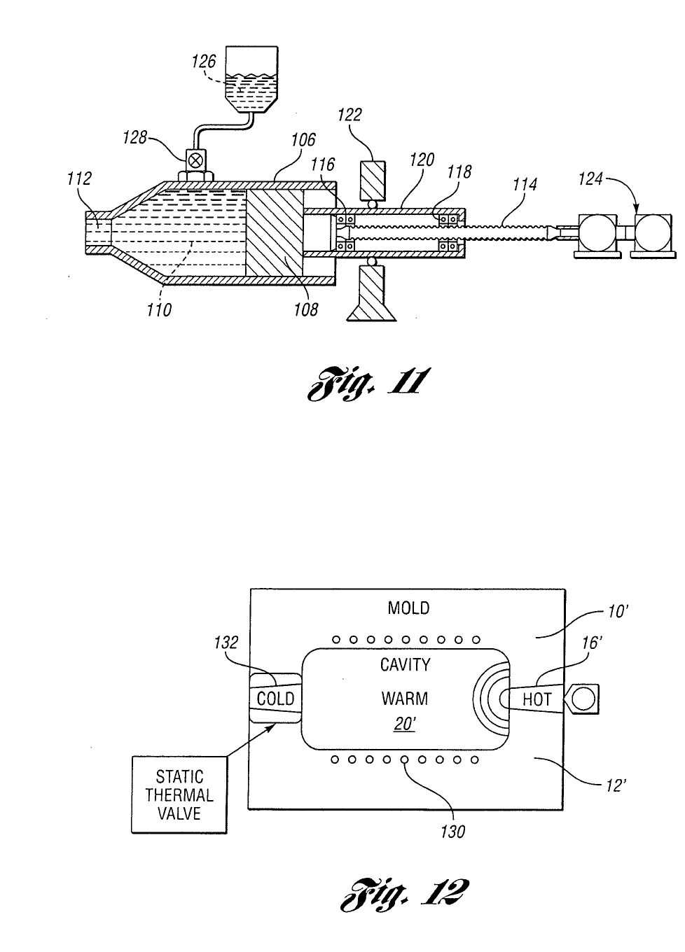

FIG. 11 is a schematic representation of a positive displacement pump for filling the mold cavity with color material during execution of the injection coating technology. A pump comprises a cylinder 106 and a piston 108, which define a pump cavity 110. As the piston is stroked in a left-hand direction as viewed in FIG. 11, color coating material is discharged from or drawn into the pump chamber through port 112, which communicates with the mold cavity through valve structure previously described. FIG. 11 shows one example of any of a variety of pump arrangements that can be used.

The piston 108 is driven by a ball screw 114 that registers with floating ball nuts 116 and a fixed ball nut 118. A piston rod 120 is appropriately supported by a fixed steady rest 122. A stepper motor assembly 124 is adapted to drive the ball screw 114.

A refill tank 126 communicates with the pump chamber 110 through a refill control valve 128 to supply makeup quantities of color coating material.

FIG. 12 shows, in schematic form, a mold for manufacturing color coded molded parts in which the substrate uses a polyurethane resin. The substrate enters the mold cavity 20′ defined by the mold sections 10′ and 12′. Entry of the substrate is through a port 16′. The substrate can be heated as it enters the cavity 20′. The cavity is filled with color material prior to entry of the substrate, as previously described. The cavity 20′ can be heated using a heater coil winding shown at 130 if additional heat is required during the curing stage.

A thermal valve, shown at 132, is located at the last point of fill of the substrate, as previously described. The substrate can be heated as it enters the cavity 20′ and part 16′ and the valve 132 can be cool. If the color material has a polyurethane binder, the viscosity of the polyurethane binder increases with increased temperature, and drops in viscosity at reduced temperature. The substrate viscosity, on the other hand, decreases with increased temperature and increases with reduced temperature. If the binder is fluid when it is cold and the substrate is fluid when it is hot when the substrate advances toward the valve 132 during the injection step, the valve will effectively seal the cool exit opening at the valve thereby preventing the heated substrate from being discharged after the color coating material is evacuated from the cavity 20′.

Although embodiments of the invention have been disclosed, it will be apparent to a person skilled in this art that modifications may be made without departing from the scope of the invention. All such modifications and equivalents thereof are intended to be defined by the following claims.

What is claimed is:

1. A method for manufacturing a color-coated molded plastic part using a mold with mold sections that define a mold cavity when they assume a closed position, the method comprising the steps of:
filling the mold cavity with color material when the mold sections are in a closed position;
filling the mold cavity with a substrate material after the mold cavity is filled with color material in synchronism with evacuation of the color material from the cavity whereby the color coating material forms a colored layer deposited on mold cavity walls of the mold sections, the colored layer adhering to the substrate as the substrate enters the mold cavity;
the evacuation of color material from the mold cavity being at a location corresponding to a last point of fill for the substrate; and
opening the mold sections to remove the part.

2. The method set forth in claim 1 wherein the substrate and the color material are cured including curing in the mold cavity prior to opening the die sections.

3. The method set forth in claim 1 wherein the color coating is selected from a group of color coating materials including a loose solid, a liquid, a semi-solid and a combination thereof.

4. The method set forth in claim 3 wherein the color coating includes a predetermined percentage of rough particles selected from a group that includes glass spheres, metallic flakes, and other suitable fillers.

5. The method set forth in claim 1 wherein the curing of the substrate and the color material may include a post molding curing process.

6. The method set forth in claim 1 wherein depositing color coating on the mold cavity walls of the mold includes depositing the color coating in multiple layers.

7. The method set forth in claim 1 wherein coating material is displaced from the mold cavity by the substrate material upon entry of substrate material into the mold cavity.

8. A method for manufacturing color-coated molded plastic parts using a mold with mold sections that define a mold cavity when they assume a closed position, the mold parts including a flow control value at a point of entry of color material into the mold cavity and a substrate entry port at a location in the mold cavity remote from the flow control valve, the method comprising the steps of:
filling the mold cavity with color material when the mold sections are in the closed position;
filling the mold cavity with a substrate material after the mold cavity is filled with color material whereby the color material is evacuated through the flow control valve;
the color material adhering to walls of the mold cavity to form a color coating as the substrate enters the cavity whereby the color coating is applied to the substrate; and
curing the substrate and the color coating in the mold cavity.

9. The method set forth in claim 8 wherein the valve is a thermal valve and the substrate includes a binder material, the viscosity of which is high when it is warm and low when it is cool whereby the valve functions as a thermal valve to contain the substrate within the cavity as the cavity is completely filled.

10. The method set forth in claim 9 wherein the steps of filling the mold cavity include reducing the temperature of the thermal valve, the temperature of the substrate as it enters the mold cavity being higher than the temperature of the thermal valve.

11. The method set forth in claim 9 wherein the binder material is a polyurethane resin.

12. The method set forth in claim 11 wherein the step of curing the substrate includes heating the substrate material in advance of entry of the substrate material into the cavity through the substrate entry port.

13. A method for manufacturing a color-coated molded plastic part in a series in which at least one part has a different color than at least one other part in the series as parts are manufactured on demand, the method using a mold with mold sections that define a mold cavity when they assume a closed position and multiple color material reservoirs, the reservoirs storing color material of differing colors, and means for distributing color material from the reservoirs to the mold cavity including distributing selectively color material to the mold cavity in response to a color selection command, the method comprising the steps of:
filling the mold cavity with color material from a selected reservoir when the mold sections are in the closed position;
filling the mold cavity with a substrate material after the mold cavity is filled with a selected color material in synchronism with evacuation of the color material from the cavity whereby the color coating material forms a colored layer deposited on the mold cavity walls of the mold sections, the color layer adhering to the substrate as the substrate enters the mold cavity;
the filling of the mold cavity with a selected color material being preceded by establishing a color coating material distribution path from a selected reservoir;
the evacuation of color material from the mold cavity being at a location corresponding to the last point of fill for the substrate; and
opening the mold sections to remove the part.

14. The method set forth in claim 13 wherein the step of filling the mold cavity with a selected color material is preceded by a step of flushing the mold cavity with a solvent when a change of color of a molded part is selected during manufacture of molded parts in series.
